(19) United States
(12) Patent Application Publication
(10) Pub. No.: US 2007/0062416 A1
(43) Pub. Date: Mar. 22, 2007

(54) Patching composition having tailorable appearance properties

(76) Inventors: John E. Brzuskiewicz, Fountain Hills, AZ (US); Robert Lowell Parkison, Gilbert, AZ (US); James G. Chehovits, Mesa, AZ (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/233,219

(22) Filed: Sep. 22, 2005

(51) Int. Cl. C04B 24/34

(52) U.S. Cl. 106/657

(57) ABSTRACT

Improved patching compositions can comprise one or more mineral aggregates and a binder, wherein the composition can be substantially free of asphalt and/or asphalt products. Due to the selection of the mineral aggregate(s), optional pigments and binder components, the improved patching compositions can have a light (i.e., gray, white, off white) color such that the improved patching compositions can be used to patch light colored concrete and pavement surfaces without the unsightly appearance associated with asphalt-based patching formulations. In some embodiments, the binder can comprise a mixture of one or more resins, polymers, oils, pigments and additives.

### FIELD OF THE INVENTION

The invention relates to patching compositions for use in patching and filling voids in, for example, concrete and pavement. More specifically, the invention relates to a tailorable cold patching composition comprising mineral aggregate and a binder.

### BACKGROUND OF THE INVENTION

Compositions used to patch and/or fill voids such as cracks, depressions, potholes, deteriorated joints and the like are generally composed of an asphaltic binder and a mineral aggregate. Mineral aggregate can be defined as various sources of rock, gravel, sand, crushed stone or cinders that are used in asphalt or concrete compositions to provide the bulk of compositions and to support the loads imposed by traffic. The binder functions to hold the aggregate fraction together to provide a durable product with load carrying capabilities. However, the use of asphaltic binders can result in the patch composition having a dark and/or black color, which can result in unsightly repair areas when used to patch and/or fill voids in light colored surfaces such as, for example, portland cement concrete.

As described above, the binders used in single component cold applied patching compositions generally include various types of asphalt products, which are dark such that the resulting compositions have a dark or black appearance. Cold applied patching materials comprising asphalt are described in U.S. Pat. No. 5,236,497, entitled “Cold Patch Using Recycled Roofing Waste,” U.S. Pat. No. 4,097,172, entitled “Cold-Patching,” and U.S. Pat. No. 3,930,100, entitled “Elastomeric Cold Patch For Pavement Repair,” all of which are incorporated herein by reference.

Patching materials that do not cause unsightly repair areas characteristic of asphalt patch materials generally are hot applied mixtures, multi-component mixtures or cementitious mixtures, all of which can require on-site heating, mixing of separate compositions and/or curing to facilitate patching or filing of a void. On-site heating and/or mixing of patching materials can be undesirable since heating and mixing can increase the time and expense associated with patching voids. Examples of these types of patching materials are described in U.S. Pat. No. 5,244,304, entitled “Cement Based Patching Composition For Asphalt Pavement,” and U.S. Pat. No. 5,075,358, entitled “Multiple Purpose Patching Composition,” both of which are hereby incorporated by reference herein.

With the number of concrete and pavement surfaces having voids or cracks, it would be desirable to provide a patching composition that addresses the above-mentioned limitations.

### SUMMARY OF THE INVENTION

Improved patching compositions can comprise one or more mineral aggregates and a binder, wherein the composition can be substantially free of asphalt and/or asphalt products. Due to the selection of the mineral aggregate(s), optional pigments and the absence of substantial amounts of asphalt, the improved patching compositions can have a light (i.e., gray, white, off white) color such that the improved patching compositions can be used to patch light colored concrete and pavement surfaces without the unsightly appearance associated with asphalt-based cold patch formulations. In some embodiments, the binder can comprise a composition having one or more resins, polymers, oils, pigments and additives. The patching compositions can be specifically tailored for different appearance properties (color, texture and the like) and/or climate conditions by adjusting the composition of the binder. Additionally, the appearance properties of the compositions can be tailored by adjusting the size grades and/or types of aggregates used to form the patching compositions. In other words, the patching compositions of the present disclosure can be tailored to have appearance properties similar to the area surrounding the void, which can improve the aesthetics of the patched surface. The patching compositions of the present disclosure can be compositions that do not require on-site heating or mixing in order facilitate suitable filling or patching a void, which can reduce the time and expense associated with patching and filling voids in concrete and other surfaces.

As described above, the patching compositions of the present disclosure can be tailored to have appearance properties similar to the surrounding repair areas. For example, if the pavement surrounding the repair area has an off-white color, the patching composition can be adjusted to have an off-white color. The color of the patching composition can be tailored by adjusting the composition of the binder, adjusting the mixture of aggregate material or combinations thereof. More specifically, the color of the binder can be adjusted by, for example, varying the pigment(s), resin(s) and/or polymer(s) employed in a particular formulation. Generally, reflectance measurements, such as hemispherical reflectance, can be used to describe the color transition from white to black in the visible spectrum of light. For example, reflectance can be defined as the ratio of radiation reflected by a surface to the amount of radiation incident on the surface, in the visible spectrum. ASTM E903-96 provides a test procedure for measuring reflectance and is incorporated herein by reference. White samples will generally have a reflectance of about 80% or higher, while black samples can have a reflectance of about 20% or less. Thus, gray samples generally have a reflectance between about 20% and about 80%. In some embodiments, the patching compositions of the present disclosure can have a reflectance from about 5% to about 99%, while in other embodiments the patching compositions can have a reflectance from about 20% to about 99%, as determined by ASTM E903-96.

The texture of the patching composition can be tailored by adjusting the mixture of the aggregate material and/or by adjusting the size of the aggregate employed in a particular formulation. For example, blending of desired aggregates can produce a patching composition having a mottled appearance. The patch compositions can also be tailored to the size of a particular void. In general, the size and gradation of the aggregate, or aggregate blend, employed in a particular formulation can be varied depending upon the size of the void to be repaired. For example, compositions designed to fill smaller voids can comprise finer grade aggregates, while compositions designed to fill larger voids can comprise larger grade aggregates. In some embodiments, the patch compositions can be applied without priming the surrounding area, which can also decrease the time required to patch a void. Moreover, the patch compositions of the present disclosure can be applied to both wet and dry voids and still form suitable patches.

Additionally, the binder employed in the compositions of the present disclosure can be tailored for use over a range of temperatures and/or climate conditions. In general, the stiffness of the binder can affect the workability of the patch material, and the stiffness of the binder tends to vary with temperature. Thus, the components of the binder can be tailored such that the binder can have a desired stiffness or softening point at a desired temperature. For example, binders designed for use in warmer climates can comprise a resin with a higher softening point, while binders designed for use in cooler climates can comprise a resin with a lower softening point.

In some embodiments, the compositions of the present invention are cold applied mixtures that are substantially free of water and do not require the addition of heat, water or other compositions at the repair site in order to facilitate suitable patching and filling of voids. Since the compositions of the present disclosure do not require on-site addition of heat, water or other compositions, the compositions can reduce the time and expense associated with patching voids. Additionally, the binders of the present disclosure, due to the combination of appropriate oils, resins and polymers, can have a reduced surface tack after compaction, which can reduce or eliminate the incorporation of contaminants into the patch composition that can darken the appearance of the patch composition.

In a first aspect, the invention pertains to a cold patch composition comprising from about 88 percent by weight to about 97 percent by weight aggregate and from about 2 percent by weight to about 12 percent by weight binder, the binder comprising a hydrocarbon resin, a polymer and a first oil. In some embodiments, the binder can further comprise a pigment and a second oil. In these embodiments, the composition can be substantially free of asphalt. Additionally, in these embodiments, a portion, or all, of the aggregate can be light colored aggregate.

In a second aspect, the invention pertains to a patching composition comprising a composition comprising a mineral aggregate and a resin binder, wherein the composition has a color selected from the group consisting of tan, gray, white, off-white, green, blue, red and combinations thereof, and wherein the composition can harden to form a patch for a void suitable to support loads imposed by traffic upon exposure to the ambient atmosphere.

In a third aspect, the invention pertains to a method of forming a patching composition comprising blending a mineral aggregate and a resin binder to form a patching composition having the approximate color of a pavement section, the color of the pavement section being selected from the group consisting of tan, gray, white, off-white, green, blue, red, and combinations thereof. In these embodiments, the patching composition can harden to form a patch for a void suitable to support loads imposed by traffic upon exposure to the ambient atmosphere.

In a fourth aspect, the invention pertains to a cold patching composition comprising mineral aggregate and a binder, wherein the binder comprises a first oil and a second oil. In these embodiments, the first oil can have a viscosity from about 75 to about 140 cSt at 40° C. before blending with other binder components, and the second oil can have a viscosity from about 1.5 to about 15 cSt at 40° C. before blending with other binder components.

### DETAILED DESCRIPTION OF THE INVENTION

The patching compositions of the present disclosure can comprise from about 80 percent by weight to about 97 percent by weight mineral aggregate. In other embodiments, the patching compositions can comprise from about 88 percent by weight to about 95 percent by weight mineral aggregate. Additionally, the patching composition can comprise from about 2 percent by weight to about 12 percent by weight binder. In some embodiments, the binder can comprise a mixture of resin(s), polymer(s) and oil(s). Additionally, the binder can further include optional pigments and/or additives such as, for example, surfactants, thermal stabilizers, antioxidants, fibers and the like and combinations thereof. As described below, the blend of aggregates and/or the composition of the binder can be adjusted such that specific formulations can be tailored to have desired performance and appearance properties.

In some embodiments, the patching compositions can be substantially free of asphalt and/or asphalt products. The term substantially free of asphalt and/or asphalt products is being used to indicate that the compositions of the present disclosure can contain less than about 5 percent by weight, preferably less than 2 percent by weight, and more preferably less than 1 percent by weight asphalt and/or asphalt products. Reducing and/or eliminating the asphalt component of the patch material can lighten the color of the resulting patch material, which facilitates using the patch material to fill voids in, for example, light colored surfaces.

As described above, the patching compositions can comprise one or more aggregates, which provide the bulk material of the composition that can support traffic and other loads. In some embodiments, a portion, or all of, the aggregate can be light colored aggregate, which facilitates producing patching compositions that have a light color. In general, any light colored aggregate, or blend of light colored aggregates, having desired texture and appearance properties can be used in the cold patch formulations of the present invention. Suitable light colored aggregates include, for example, marble, white limestone, crystalline dolomite, granite, basalt, quartz, river gravel, coral rock, sandstone, blue slate and combinations thereof. In some embodiments, the light color aggregate(s) can be selected such that the resulting cold patch formulation has a desired light (i.e., gray, white, off white, etc.) appearance to match the appearance of the surrounding pavement or concrete.

Additionally, the gradation of the aggregate can be adjusted depending on the size of the void to be repaired. For example, cold patch formulations designed to fill deep voids can comprise large size or coarse gradation aggregates, while cold patch formulations designed to fill shallow voids can comprise small size or fine gradation aggregates. The fine gradation can be selected such that about 95 to about 100 percent of the aggregate passes through a ¼″ sieve and from about 75 to about 96 percent of the aggregate passes through a number 4 sieve. The course gradation aggregate can be selected such that from about 95 to about 100 percent of the aggregate passes through a ⅜″ sieve and from about 60 to about 80 percent of the aggregate passes through a ¼″ sieve. In some embodiments, the mineral aggregate can have a size gradation less than about 1.5 inches, while in other embodiments the mineral aggregate can have a size gradation from about 0.25 inch to about 1.25 inches. Additionally, the mineral aggregate can comprise 100 percent crushed aggregate.

In some embodiments, the patching compositions can include from about 80 percent by weight to about 97 percent by weight light colored aggregate, while in other embodiment the cold patch formulation can include from about 85 percent by weight to about 90 percent by weight light colored aggregate. One of ordinary skill in the art will recognize that additional ranges of light colored aggregate within these explicit ranges are contemplated and are within the scope of the present disclosure. Additionally, in some embodiments, dark colored aggregate(s) can be added to the composition to darken the overall color of the patch material. For example, in embodiments where the desired color of the patch material is a dark gray, the composition can comprise from about 1 percent by weight to about 15 percent by weight dark aggregate(s). Dark aggregates include, for example, aggregates having a black color and/or a “salt and pepper” color. Suitable dark aggregates include, for example, dark basalts, dark slates, dark granites, dark fines and combinations thereof.

The patching compositions generally comprise aggregate and an appropriate binder that can hold the aggregate fraction together. The binder can comprise a mixture of one or more oils, resins, polymers, pigments and additives. In some embodiments, the patching formulations of the present disclosure can comprise from about 2 percent by weight to about 12 percent by weight binder, which facilitates binding the aggregate into a suitable material for patching a void. Generally, the ratio of binder to aggregate in a particular formulation can be guided by the surface area of the aggregate and the absorption of the binder by the aggregate.

In some embodiments, the major component of the binder can be one or more hydrocarbon resins. In general, the hydrocarbon resins can help promote adhesion between the binder and the aggregate and/or the patching composition and the surrounding repair area. Suitable hydrocarbon resins include, for example, aliphatic C5 petroleum hydrocarbon resins, C6-C20 hydrogenated hydrocarbon resins, polyterpene resins, rosin esters, rosin tall oil esters, aromatic resins and combinations thereof. Suitable C5 petroleum hydrocarbon resins are sold under the tradename WINGTACK® by Goodyear Chemical (Akron, Ohio). Suitable hydrogenated hydrocarbon resins are sold under the tradename EASTOTAC by Eastman Chemical Company (Kingsport, Tenn.). In some embodiments, the hydrocarbon resin(s) can be present in the binder at a concentration from about 25 percent by weight to about 75 percent by weight, while in other embodiments the hydrocarbon resin(s) can be present in the binder at a concentration from about 40 percent by weight to about 60 percent by weight. One of ordinary skill in the art will recognize that additional ranges of hydrocarbon resin concentration within these explicit ranges are contemplated and are within the scope of the present disclosure.

The binder can further comprise one or more polymers, which can provide increased strength and/or flexibility to the binder. The selection of a particular polymer(s) can be guided by desired performance properties such as stiffness, abrasion resistance, tensile strength and the like. In general, the polymer can be any elastomer, plastomer or combination thereof suitable for use in patching applications. Suitable elastomers and plastomers include, for example, styrene-butadiene-styrene block co-polymers, styrene-isoprene-styrene block co-polymers, styrene butadiene rubber, butadiene-acrylonitrile, butadiene, natural isoprene, synthetic isoprene, polychloroprene, butyl rubber, butane polymers, isobutyl polymers, ethylene vinyl acetate (EVA), and combinations thereof. Suitable polymers include, for example, polyethylene (PE), high density polyethylene (HDPE), polypropylene (PP), polyvinylchloride (PVC), polyurethanes, polycarbonates, recycled polymers, reclaimed rubber and blends and copolymers thereof.

In some embodiments, the polymer(s) can be present in the binder at a concentration from about 2 percent by weight to about 20 percent by weight, while in other embodiments the polymer(s) can be present in the binder from about 5 percent by weight to about 10 percent by weight. In one embodiment, the binder can comprise an elastomer and a plastomer, wherein the elastomer is present in the binder at a concentration from about 2 to about 6 percent by weight, and wherein the plastomer is present in the binder at a concentration from about 2 percent to about 8 percent by weight.

In some embodiments, the binder can comprise one or more oils. In one embodiment, the binder can comprise a first oil that is used a process aid and a second oil that can function as a viscosity modifying agent. The first oil can facilitate mixing of the resin and polymer at elevated temperatures during processing of the binder, while the second oil can be used to reduce the viscosity of the composition and make the binder/aggregate mixture easier to work with and compact. In general, the oils employed in the patching compositions can be any oil that facilitates processing of the binder and/or facilitates reducing the viscosity of the patching composition. In one embodiment, the first oil can be a naphthenic oil, aromatic oil, a paraffinic oil or combinations thereof, while the second oil can be naphthenic oil, an aromatic oil, a paraffinic oil, kerosene, mineral spirits, naphtha or combinations thereof. In some embodiments, the process oil can have a viscosity from about 75 to about 140 centistokes (cSt) at 40° C. Suitable naphthenic process oils include naphthenic oils having a viscosity from about 75 to about 140 cSt at 40° C. Suitable naphthenic process oils are sold under the tradename RENOIL by Renkert Oil (Elverson, Pennsylvania) and under the tradename NYFLEX by Nynas (Stockholm, Sweden). Suitable viscosity modifying oils include oils having a viscosity from about 1.5 to about 15 cSt at 40° C. Suitable viscosity modifying oils are sold under the tradename CORSOL by Cross Oil (Smackover, Ark.). Other suitable viscosity modifying oils include, for example, L-Series oils manufactured by Cross Oil.

The first oil, or process oil, can be present in the binder at a concentration from about 10 percent by weight to about 30 percent by weight, while the second oil can be present in the binder at a concentration from about 10 percent by weight to about 40 percent by weight. One of ordinary skill in the art will recognize that additional ranges of first and second oil concentration within these explicit ranges are contemplated and are within the scope of the present disclosure.

The binder can comprise one or more pigments, which can facilitate desired appearance of the patching composition. In general, any inorganic pigment, organic pigment or combination thereof that produces a desired color can be used in the compositions of the present disclosure. The pigments can be, for example, gray pigments, white pigments, black pigments, red pigments, blue pigments and combinations thereof. Suitable pigments include, for example, titanium dioxide, calcium carbonate, carbon black, red iron oxide, black iron oxide, ultramarine blue, and combinations thereof. In embodiments employing one or more. pigments, the pigments are generally present in the binder at a concentration from about 0.5 percent by weight to about 5 percent by weight, and in other embodiments from about 1 percent by weight to about 3 percent by weight.

The binder can further comprise additives that modify and/or further tailor the properties of the binder. Suitable additives include, for example, surfactants, waxes, antioxidants, ultraviolet stabilizers, thermal stabilizers, other resins, fibers and combinations thereof. In one embodiment, an amine surfactant can be added to the binder, which can improve the bonding properties of the binder to the aggregate and can also help the cold patch composition adhere to the surrounding repair area or void. Suitable amine surfactants include, for example, SC-901 manufactured by ArrMaz Chemicals (Winter Haven, Fla.) and PAVE® 192 manufactured by Rohm and Haas (Philadelphia, Pa.). Fibers, such as, for example, polyester, polypropylene, and cellulose, can be added to the binder to increase the strength of the patch material. In some embodiments, the additives can be present in the binder at a concentration of less than about 5 percent by weight, while in other embodiments the additives can be present in the binder at a concentration from about 0.1 percent by weight to about 3 percent by weight.

To form the binders of the present disclosure, desired amounts of resin and process oil can be heated to a temperature between about 300° F. and about 400° F. Thermal stabilizers, if needed, can be added after the resin melts in the oil and forms a substantially uniform fluid. Desired amounts of polymer can then be added to the heated resin/oil mixture and dispersed into the mixture by mixing. Once the polymer is dispersed uniformly into the resin/oil mixture, one or more pigments can be added into the mixture. The mixture can then be cooled and a viscosity modifying oil can be dispersed into the mixture. Finally, additional additives such as, for example, surfactants, antioxidants, fibers and ultraviolet stabilizers can be added to the mixture to form the final binder composition.

In order to form the patching composition, desired amounts of a binder can be added to desired amounts of aggregate and mixed to form an aggregate/binder composition. The binder and the aggregate can be mixed until the binder has thoroughly wetted the aggregate. In some embodiments, the binder and the aggregate can be mixed for about 5 to about 15 minutes using, for example, pugmill, paddle or an oscillating planetary mixer. Additionally, the binder may be heated prior to mixing with the aggregate to facilitate better mixing of the binder and aggregate.

In some embodiments, the patching compositions can be supplied in a premixed form in individual use packaging, while in other embodiments the patching compositions can be provided premixed in bulk quantity as a stockpile. During use, desired amounts, such as, for example, an amount sufficient to just overfill the void prior to compaction, of the patch material can be dispensed into the void. The patch material can be then compacted by any suitable means. Once the patching material has been placed in the void, exposure to the ambient atmosphere can harden the patching material such that a patch suitable to support loads imposed by traffic is formed in the void. Additionally, in some embodiments, local dust, dirt, cement dust or the like can be applied to the surface of the patch material to further refine the color and/or appearance properties of the patch material.

### EXAMPLES

The examples below illustrate that the patching compositions of the present disclosure can be tailored to have desired appearance properties. More specifically, the examples illustrate the varying of components of the binder and/or the aggregate can affect the appearance of the patching compositions. In the examples below, the binders comprise about 6.6 to about 6.8 weight percent of the patching compositions. However, in other embodiments, the binder can comprise from about 2 percent by weight to about 12 percent by weight of the patching compositions.

### Example 1

A patching composition was prepared as shown in TABLE 1 with a binder comprising a C5 hydrocarbon resin, a polymer, an elasotmer and titanium dioxide pigment. In this example the mineral aggregate was dolomite aggregate. The patching composition had a white color.

TABLE 1

| | Weight Percent of |
|---|---|
| Component | Patching Composition |
| Hydrocarbon Resin | 3.0 |
| Polymer | 0.2 |
| Elastomer | 0.3 |
| Process Oil | 1.0 |
| Carbon Black Pigment | None |
| Titanium Dioxide Pigment | 0.2 |
| Viscosity Modifying Oil | 1.8 |
| Surfactant | 0.1 |
| Aggregate-Dolomite | 93.4 |

### Example 2

A patching composition was prepared as shown in TABLE 2 with a binder comprising a C5 hydrocarbon resin, a polymer, an elastomer, carbon black pigment and titanium dioxide pigment. The mineral aggregate employed in this example was a limestone aggregate. The patching composition had a light gray color.

TABLE 2

| | Weight Percent of |
|---|---|
| Component | Patching Composition |
| Hydrocarbon Resin | 3.0 |
| Polymer | 0.2 |
| Elastomer | 0.3 |
| Process Oil | 1.0 |
| Carbon Black Pigment | Less than 0.1 |
| Titanium Dioxide Pigment | 0.3 |
| Viscosity Modifying Oil | 1.7 |
| Surfactant | 0.1 |
| Aggregate-Limestone | 93.4 |

### Example 3

A patching composition was prepared as shown in TABLE 3 with a binder comprising a C6-C20 hydrocarbon resin, a polymer, carbon black pigment and titanium dioxide pigment. The mineral aggregate employed in this example was dolomite aggregate. The patching material had a light gray color.

TABLE 3

| | Weight Percent of |
|---|---|
| Component | Patching Composition |
| Hydrocarbon Resin | 2.8 |
| Polymer | 0.8 |
| Elastomer | None |
| Process Oil | 0.7 |
| Carbon Black Pigment | Less than 0.1 |
| Titanium Dioxide Pigment | 0.3 |
| Viscosity Modifying Oil | 1.9 |
| Surfactant | 0.1 |
| Aggregate-Dolomite | 93.4 |

### Example 4

A patching composition was prepared as shown in TABLE 4 with a binder comprising a C5 hydrocarbon resin, a polymer, an elastomer and titanium dioxide pigment. In this example, the mineral aggregate was basalt aggregate. The patching composition had a gray color.

TABLE 4

| | Weight Percent of |
|---|---|
| Component | Patching Composition |
| Hydrocarbon Resin | 3.1 |
| Polymer | 0.2 |
| Elastomer | 0.3 |
| Process Oil | 1.1 |
| Carbon Black Pigment | None |
| Titanium Dioxide Pigment | 0.2 |
| Viscosity Modifying Oil | 1.9 |
| Surfactant | 0.1 |
| Aggregate-Basalt | 93.1 |

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What is claimed is

1. A method of forming a patching composition comprising:
blending a mineral aggregate and a resin binder to form a patching composition having the approximate color of a pavement section, the color of the pavement section being selected from the group consisting of tan, gray, white, off-white, green, blue, red and combinations thereof, wherein the patching composition hardens upon exposure to the ambient atmosphere.

2. The method of claim 1 wherein the resin binder comprises a hydrocarbon resin selected from the group consisting of aliphatic C5 petroleum hydrocarbons, C6-C20 hydrogenated hydrocarbon resins, polyterpene resins, rosin esters, rosin tall oil esters, aromatic resins, and combinations thereof.

3. The method of claim 1 wherein resin binder comprises a polymer selected from the group consisting of styrene-butadiene-styrene block copolymers, styrene-isoprene-styrene block copolymers, styrene butadiene rubber, butadiene-acrylonitrile, butadiene, natural isoprene, synthetic isoprene, polychloroprene, butyl polymers, butyl rubber, isobutyl polymers, ethylene vinyl acetate and combinations thereof.

4. The method of claim 1 wherein the resin binder further comprises a process oil selected from the group consisting of naphthenic oil, aromatic oil, paraffinic oil and combinations thereof.

5. The method of claim 1 wherein the patching composition further comprises an amine surfactant.

6. The method of claim 1 wherein the patching composition comprises a pigment, and wherein the method further comprises selecting the composition and relative amount of the pigment such that the patching composition has the approximate color of a pavement section.

7. The method of claim 6 wherein the pigment is selected from the group consisting of titanium dioxide, calcium carbonate, carbon black, red iron oxide, black iron oxide, ultramarine blue, organic pigments and combinations thereof.

8. The method of claim 1 wherein the patching composition has the approximate color of new portland cement concrete or aged portland cement concrete.

9. The method of claim 1 further comprising placing a desired amount of the patching composition in a void and compacting the patching composition to form a patch for the void.

10. A patching composition comprising:
a mineral aggregate and a binder, wherein the composition has a color selected from the group consisting of tan, gray, white, off-white, green, blue, red and combinations thereof, and wherein the patching composition hardens upon exposure to the ambient atmosphere.

11. The patching composition of claim 10 wherein from about 95 to about 100 percent of the mineral aggregate passes through a ¼″ sieve and wherein from about 75 to about 96 percent of the mineral aggregate passes through a number 4 sieve.

12. The patching composition of claim 10 wherein the binder comprises a hydrocarbon resin selected from the group consisting of aliphatic C5 petroleum hydrocarbons, C6-C20 hydrogenated hydrocarbon resins, polyterpene resins, rosin esters, rosin tall oil esters, aromatic resins, and combinations thereof.

13. The patching composition of claim 10 wherein binder further comprises a first polymer selected from the group consisting of styrene-butadiene-styrene block copolymers, styrene-isoprene-styrene block copolymers, styrene butadiene rubber, butadiene-acrylonitrile, butadiene, natural isoprene, synthetic isoprene, polychloroprene, butyl polymers, butyl rubber, isobutyl polymers, ethylene vinyl acetate and combinations thereof.

14. The patching composition of claim 10 wherein binder comprises a process oil, and wherein the process oil has a viscosity from about 75 cSt to about 140 cSt at 40° C. before combination with other binder components.

15. The patching composition of claim 13 wherein the binder further comprises a second polymer, wherein the second polymer is selected from the group consisting of styrene-butadiene-styrene block copolymers, styrene-isoprene-styrene block copolymers, styrene butadiene rubber, butadiene-acrylonitrile, butadiene, natural isoprene, synthetic isoprene, polychloroprene, butyl polymers, butyl rubber, isobutyl polymers, ethylene vinyl acetate and combinations thereof.

16. The patching composition of claim 15 wherein the second polymer comprises a plastomer and wherein the plastomer comprises from about 2 percent to about 8 percent by weight of the binder.

17. The patching composition of claim 13 wherein the first polymer comprises an elastomer and wherein the elastomer comprises from about 2 percent to about 6 percent by weight of the binder.

18. The patching composition of claim 10 wherein the binder comprises a pigment selected from the group consisting of titanium dioxide, calcium carbonate, carbon black, red iron oxide, black iron oxide, ultramarine blue, organic pigments and combinations thereof.

19. The patching composition of claim 10 wherein the mineral aggregate is present in the composition at a concentration from about 80 percent to about 97 percent by weight.

20. The patching composition of claim 10 wherein the binder is present in the composition at a concentration from about 2 percent to about 12 percent by weight.

21. A cold patch composition comprising:
from about 88 percent by weight to about 97 percent by weight aggregate; and
from about 2 percent by weight to about 12 percent by weight binder, wherein the cold patch composition is substantially free of asphalt.

22. The cold patch composition of claim 21 wherein the aggregate is selected from the group consisting of marble, white limestone, crystalline dolomite, granite, basalt, river gravel, coral rock, sandstone, blue slate and combinations thereof.

23. The cold patch composition of claim 21 wherein the binder comprises a polymer is selected from the group consisting of styrene-butadiene-styrene block co-polymers, styrene-isoprene-styrene block co-polymers, styrene butadiene rubber, butadiene-acrylonitrile, butadiene, natural isoprene, synthetic isoprene, polychloroprene, butyl rubber, butane polymers, isobutyl polymers, ethylene vinyl acetate (EVA), and combinations thereof.

24. The cold patch composition of claim 21 wherein the binder comprises a process oil selected from the group consisting of naphthenic oil, aromatic oil, paraffinic oil and combinations thereof.

25. The cold patch composition of claim 24 wherein the first oil has a viscosity from about 75 to about 140 cSt at 40° C. before combination with other binder components.

26. The cold patch composition of claim 21 wherein the binder comprises a second oil selected from the group consisting of naphthenic oil, aromatic oil, paraffinic oil, kerosene, mineral spirits, naphtha and combinations thereof.

27. The cold patch composition of claim 26 wherein the second oil has a viscosity from about 1.5 to about 15 cSt at 40° C. before combination with other binder components.

28. The cold patch composition of claim 21 wherein the binder comprises a hydrocarbon resin is selected from the group consisting of aliphatic C5 petroleum hydrocarbons, C6-C20 hydrogenated hydrocarbon resins, polyterpene resins, rosin esters, rosin tall oil esters, aromatic resins, and combinations thereof.

29. The cold patch composition of claim 21 wherein the binder further comprises a pigment.

30. The cold patch composition of claim 29 wherein the pigment is selected from the group consisting of titanium dioxide, calcium carbonate, carbon black, red iron oxide, black iron oxide, ultramarine blue, organic pigments and combinations thereof.

31. The cold patch composition of claim 21 wherein the binder further comprises an additive selected from the group consisting of an amine surfactant, a thermal stabilizer, an antioxidant, an ultraviolet stabilizer, a fiber and combinations thereof.

32. The cold patch composition of claim 21 wherein the aggregate comprises dark colored aggregates.

33. The cold patch composition of claim 32 wherein the dark colored aggregates are selected from the group consisting of dark slates, dark basalts, dark granites, dark fines and combinations thereof.

34. A cold patching composition comprising mineral aggregate and a binder, wherein the binder comprises a first oil and a second oil, wherein the first oil has a viscosity from about 75 to about 140 cSt at 40° C. before combination with other binder components, and wherein the second oil has a viscosity from about 1.5 to about 15 cSt at 40° C. before combination with other binder components.

35. The cold patching composition of claim 34 wherein the binder further comprises a polymer selected from the group consisting of styrene-butadiene-styrene block co-polymers, styrene-isoprene-styrene block co-polymers, styrene butadiene rubber, butadiene-acrylonitrile, butadiene, natural isoprene, synthetic isoprene, polychloroprene, butyl rubber, butane polymers, isobutyl polymers, ethylene vinyl acetate (EVA), and combinations thereof.

36. The cold patching composition of claim 34 wherein the binder further comprises a pigment.
